(19) United States
(12) Patent Application Publication
(10) Pub. No.: US 2026/0337793 A1
(43) Pub. Date: Oct. 29, 2026

(54) A METHOD OF OPERATING AN ELECTROCHEMICAL STACK, AN ELECTROCHEMICAL CELL AND AN ELECTROCHEMICAL STACK

(71) Applicant: Robert Bosch GmbH, Stuttgart (DE)

(72) Inventors: Li Wang, Tilburg (NL); Arie van der Velde, Tilburg (NL)

(21) Appl. No.: 19/485,314

(22) PCT Filed: May 19, 2023
(86) PCT No.: PCT/EP2023/063466

§ 371 Date: Nov. 18, 2025

(51) Int. Cl. C25B 9/70; C25B 1/04; C25B 9/60

(52) U.S. Cl. CPC C25B 9/70; C25B 9/60; C25B 1/04

(57) ABSTRACT

The invention relates to a method of operating an electrochemical stack (1), in particular an electrolysis stack, comprising a plurality of electrochemical cells (2), in particular electrolysis cells, comprising the steps—supplying the cells (2) with a fluid via inlet channels (3) that extend in stacking direction through the stack (1) and are provided on opposite sides (S1, S2) of the stack (1) and discharging the fluid via outlet channels (4) that extend in stacking direction through the stack (1) and are provided opposite the inlet channels (3), such that the fluid flows through each cell (2) in two substantially opposite directions (D1, D2). The invention further relates to an electrochemical cell (2) and an electrochemical stack (1).

### BACKGROUND

The present invention relates to a method of operating an electrochemical stack, for example an electrolysis stack or a fuel cell stack. Furthermore, the present invention relates to an electrochemical cell and an electrochemical stack, for example an electrolysis stack or a fuel cell stack.

A stack of electrochemical cells, such as a fuel cell or an electrolysis stack is well known in the art. Each cell in the stack has a layered construction, typically comprising:
An electrically insulating and chemically separating, but ion conducting (composite polymer) membrane with a respective electrode/catalyst layer provided on either side thereof, forming an anode and a cathode The anode and cathode catalyst layers comprise catalyst particles mixed with binder and support materials, typically an ionomer. This layered assembly of the membrane and the electrodes is often referred to as membrane electrode assembly (MEA) or catalyst coated membrane (CCM), the latter referring to the conventional MEA production process of coating the membrane with the electrode catalyst mixture dissolved in a volatile solvent.
A porous transport or gas diffusion layer (PTL/GDL) on either side of the MEA/CCM for carrying electric current to or away from the electrodes, while allowing electrolyte and/or the electrochemical reactant(s) and product(s) to be supplied to or carried away from a respective electrode of the CCM. In some publications on electrochemical stacks, the MEA is defined to include the PTL/GDL. In fact, the catalyst can be applied to the PTL/GDL, instead of the membrane, in which case the thus coated PTL/GDL is typically referred to as a porous transport electrode (PTE). The PTL/GDL can be provided as a metal foam, (sintered) metal powder, metal fibers/whiskers felt or mesh, (woven or non-woven) carbon fibers and the like. Effective porosity, average pore size, tortuosity, as well as electric conductance are all relevant characteristics of the PTL/GDL.
A metal “bipolar” plate (BPP) shared between and mutually (chemically) separating adjacent cells for coupling electric current out of or, respectively, into these cells. The BBP can be corrugated such that it defines a fluid flow field for the transport of the electrolyte, the reactant, the product and/or a cooling medium across the active area of the cell.

Within an electrochemical stack several channels are provided along the height of the stack, i.e., along the cell stacking direction. The channels comprise inlet and outlet channels for the supply and discharge of a reactant and/or a product. They are formed by mutually overlapping holes in the BBPs and the layers present between the BBPs. Cross channels formed by corrugations of the BBPs connect the channels to the PTLs/GDLs on either the anode or cathode side of each cell.

During the operation of a water electrolysis stack, water serving as reactant is fed via an inlet channel to the respective anode side of each cell, transported through the respective PTL/GDL of each cell and allowed to exit the cells via an outlet channel. Typically, the H₂O inlet and outlet channels are provided on opposite sides of the stack to ensure a uniform distribution of the reactant across the so-called “active area” where the electrochemical reaction takes place. The active area more or less corresponds to the surface area of the respective PTL/GDL. When flowing across the active area, the water accumulates oxygen which is an electrolysis product. The oxygen content of the gas-liquid mixture increases with proximity of the outlet channel.

The water flow on the anode side not only serves to supply water as the electrolysis reactant and to remove oxygen as an electrolysis product, but also to remove waste heat from the active area of the cells. Thus, the water also has the function of a coolant. During steady state operation of the stack, the temperature of the water increases in flow direction when flowing across the cells. With the increasing temperature the reaction speed of the water electrolysis increases, such that the reaction speed varies across the cells.

Furthermore, the increasing temperature of the water boosts cell degradation due to membrane/ionomer degradation, catalyst dissolution and oxide layer formation on interfaces of different layered components, which are temperature dependent. Accordingly, the cells degrade unevenly.

### SUMMARY

The object of the present invention is to homogenize reaction speed and cell degradation across the cells of an electrochemical stack, in particular an electrolysis stack.

The object is solved by the method according to the disclosure, the electrochemical cell according to the disclosure and the electrochemical stack according to the disclosure.

The proposed method of operating an electrochemical stack, in particular an electrolysis stack, comprising a plurality of electrochemical cells, in particular electrolysis cells, comprises the steps
supplying the cells with a fluid via inlet channels that extend in stacking direction through the stack and are provided on opposite sides of the stack and
discharging the fluid via outlet channels that extend in stacking direction through the stack and are provided opposite the inlet channels, such that the fluid flows through each cell in two substantially opposite directions.

The fluid flow through the cells serves to remove waste heat. Thus, the fluid temperature increases on its way through the cells. Because of the two substantially opposite fluid flow directions through each cell the fluid temperature and thus the thermal stress on either side of each cell is substantially equal. As a result, the cell degradation caused by thermal stress is substantially uniform across the cells.

Preferably, the fluid the cells are supplied with is water. In this case the fluid serves as a reactant during the electrochemical reaction within the cells, whereby hydrogen and oxygen are produced. The oxygen is discharged from the cells together with the fluid, i.e., with the water. Thus, the term “fluid” may relate to a liquid, a gas and/or a liquid-gas-mixture.

If the fluid is a reactant, e.g., water, the fluid temperature influences the reaction speed during the electrochemical reaction within the cells. By operating the stack according to the proposed method, the fluid temperature and thus the reaction speed stay substantially uniform across the cells.

In a preferred embodiment of the invention, the fluid flow through the cells is guided by guide elements and/or cell partitions, e.g., by walls. The guiding of the fluid flow prevents cross currents between an inlet channel and an outlet channel that are provided on the same side of the stack. Thus, by guiding the fluid, fluid flow paths are defined, that extend from an inlet channel on one side of the stack to an outlet channel on the respective other side of the stack. Thereby, the fluid is uniformly distributed across the cells, in particular over their active areas.

Preferably, the fluid supplied via a single inlet channel is discharged via two or more outlet channels that are provided opposite the respective inlet channel. Thus, the fluid flow is split and distributed among two or more outlet channels. Thereby, an enlarged flow cross section for discharging the fluid is provided. This is in particular an advantage, if the fluid supplied is water and the fluid discharged is water with oxygen. Further preferably, the position of the single inlet channel is centered with regard to the two or more outlet channels to ensure uniform distribution of the fluid flow among the two or more outlet channels.

For solving the object of the invention an electrochemical cell, in particular an electrolysis cell, for an electrochemical stack, in particular an electrolysis stack, is proposed. The cell has a plurality of inlet ports provided on opposite sides of the cell and a plurality of outlet ports provided opposite the inlet ports, such that either side of the cell is provided with at least one inlet port and at least one outlet port.

The inlet ports serve to supply the cell with a fluid, e.g., with water. The fluid flows from the inlet ports to the outlet ports on the respective other side of the cell. The fluid is then discharged via the outlet ports. By positioning the inlet ports on opposite sides of the cell, the fluid flows through the cell in two substantially opposite directions. As an effect, the fluid temperature across the cell and thus the cell degradation caused by thermal stress is more uniform. Besides, provided that the fluid is a reactant, the reaction speed across the cell is homogenized.

In a preferred embodiment of the invention, inlet ports and outlet ports alternate on at least one side or on either side of the cell. In the latter case, each outlet port is allocated to an inlet port, such that the number of outlet ports corresponds to the number of inlet ports. Alternatively, the number of outlet ports varies from the number of inlet ports.

In a further preferred embodiment of the invention, the number of the outlet ports is at least twice the number of the inlet ports. Thus, two or more outlet ports are provided opposite a single inlet port and allocated to that inlet port. As an effect, the flow cross section for discharging the fluid in enlarged. This is an advantage, in particular, for an electrolysis cell, which is fed via the inlet channels with water as reactant. The water not only serves as reactant, but also serves to remove the oxygen produced during the electrochemical process in the cell. Accordingly, more fluid is discharged than supplied.

Thus, preferably, the flow cross-section of the inlet ports in total is smaller than the flow cross-section of the outlet ports in total, in particular, if the electrochemical cell is an electrolysis cell. This can be achieved by multiplying the number of outlet ports with regard to the number of inlet ports. As an alternative or in addition, the flow cross section of each inlet port can be smaller than the flow cross section of each outlet port.

Further preferably, guide elements and/or cell partitions, e.g., walls, are provided for separating flow paths with opposite flow direction. The guiding of the fluid flow prevents cross currents between an inlet port and an outlet port on the same side of the cell. Thus, the fluid is forced to flow from an inlet port to a single outlet port or to several outlet ports on the respective other side of the cell. Thereby the fluid is homogeneously distributed across the cell.

Advantageously, a plurality of electrochemical cells according to the present invention are stacked. In this arrangement, the plurality of cells form an electrochemical stack.

Thus, further proposed is an electrochemical stack, in particular an electrolysis stack, comprising a plurality of electrochemical cells, in particular electrolysis cells, according to the present invention. The proposed electrochemical stack is suitable to carry out the method according to the present invention. Thus, the same advantages can be achieved with the electrochemical stack when operated according to the inventive method. In particular, a uniform fluid temperature in operation and thus a uniform cell degradation over lifetime can be achieved. Provided that the electrochemical stack is an electrolysis stack, the temperature sensitive reaction speed across the cell can be homogenized.

Preferably, the inlet ports of the stacked cells overlap and define inlet channels extending through the stack in stacking direction. Furthermore, the outlet ports of the cells overlap and define outlet channels extending through the stack in stacking direction.

### BRIEF DESCRIPTION OF THE DRAWINGS

Preferred embodiments of the invention are explained in conjunction with the enclosed figures. The figures show:

FIG. 1 a top view of an electrochemical cell according to a first preferred embodiment of the invention,

FIG. 2 a top view of an electrochemical cell according to a second preferred embodiment of the invention,

FIG. 3 a top view of an electrochemical cell according to a third preferred embodiment of the invention,

FIG. 4 a top view of an electrochemical cell according to a fourth preferred embodiment of the invention,

FIG. 5 a top view of an electrochemical cell according to a fifth preferred embodiment of the invention,

FIG. 6 a top view of an electrochemical cell according to a sixth preferred embodiment of the invention,

FIG. 7 a cross section through an electrochemical stack according to a first preferred embodiment of the invention and

FIG. 8 a cross section through an electrochemical stack according to a second preferred embodiment of the invention.

### DETAILED DESCRIPTION

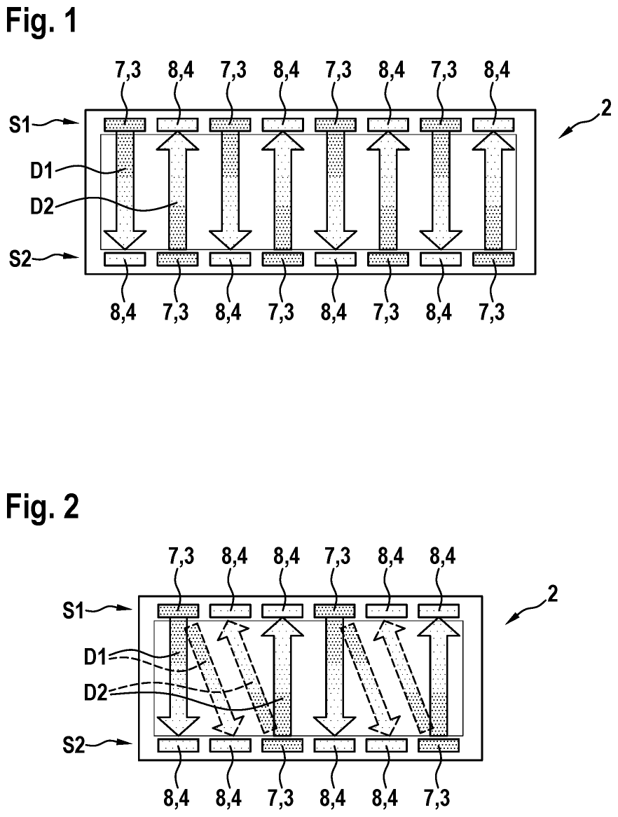

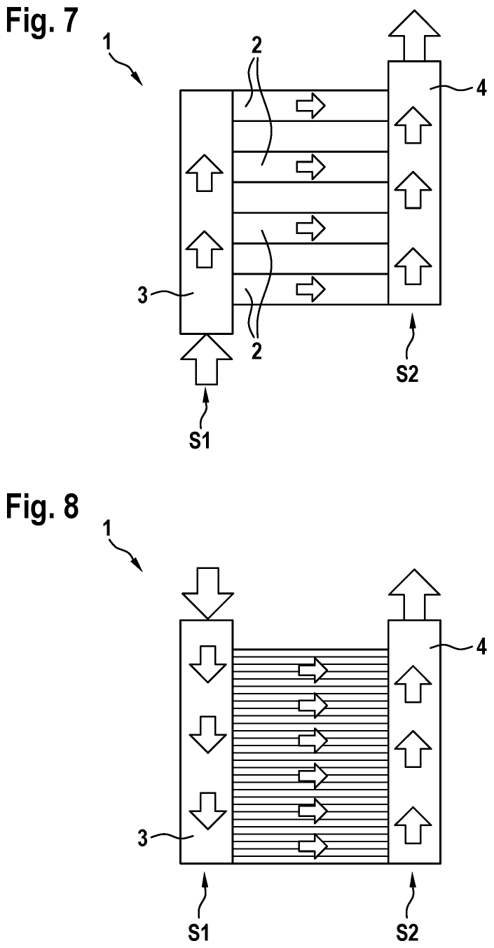

FIG. 1 shows a first preferred embodiment of an electrochemical cell 1. The cell 2 is provided with inlet ports 7 and outlet ports 8 for a fluid, e.g., a reactant, a product and/or a combination thereof. In a stack 1 comprising a plurality of identical cells 2, overlapping inlet ports 7 form inlet channels 3 and overlapping outlet ports 8 form outlet channels 4 (as shown in FIGS. 7 and 8). In FIG. 1, the inlet ports 7 and the outlet ports 8 are positioned on two opposite sides S1, S2 of the cell 2, such that the inlet ports 7 and the outlet ports 8 of each side S1, S2 alternate. The number of inlet ports 7 equals the number of outlet ports 8. Each inlet port 7 is allocated an outlet port 8 that lies opposite the inlet port 7. Thus, the fluid supplied to the cell 2 flows in two opposite directions D1, D2 through the cell 2.

Provided that the electrochemical cell 2 in FIG. 1 is an electrolysis cell, the fluid the cell 2 is supplied with is water. The water serves as a reactant during the electrolysis process within the cell 2. During said process hydrogen and oxygen are produced. The processed oxygen is removed with the water via the outlet ports 8. A further function of the water is to remove waste heat that is also generated during the electrolysis process. Thus, the temperature of the water increases with the distance to the inlet port 7, via which the water has been supplied. Due to the fact that cell degradation and reaction speed are influenced by the fluid temperature, a uniform fluid temperature across the cell 2 is an advantage. According to the invention, this is achieved by supplying the cell 2 with fluid from two opposite sides S1, S2.

FIG. 2 shows another preferred embodiment of an inventive electrochemical cell 2, in particular an electrolysis cell. In this embodiment, two outlet ports 8 are allocated to a single inlet port 7, such that the number of outlet ports 8 is twice the number of inlet ports 7. Accordingly, the flow cross section of the outlet ports 8 in total is larger than the flow cross section of the inlet ports 7 in total. This arrangement facilitates the removal of oxygen via the outlet ports 8. The fluid flow from an inlet port 7 to an outlet port 8 is split and distributed among the two outlet ports 8. Because on either side S1, S2 of the cell 2 the number of inlet ports 7 or outlet ports 8, respectively, is the same, the fluid is uniformly distributed across the cell 2.

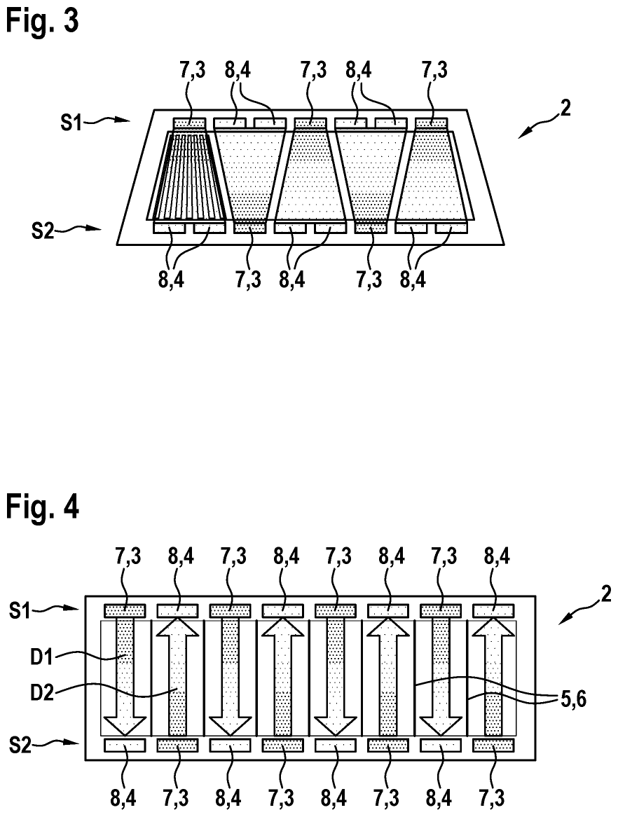

To further enhance a uniform fluid distribution, the inlet ports 7 can be positioned exactly midway of the two outlet ports 8 on the respective opposite side of the cell 2, as shown in FIG. 3.

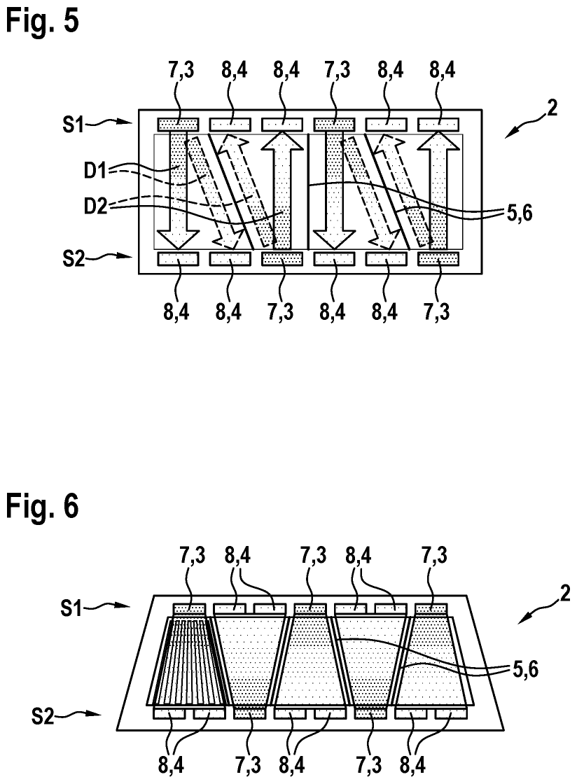

The preferred embodiments in FIGS. 4 to 6 resemble to the embodiments shown in FIG. 1 to 3 with the only difference that flow paths are defined by guide elements 5 and/or cell partitions 6. The guide elements 5 or cell partitions 6 can be realized by walls that separate flow paths with opposite flow directions D1, D2. Thereby the walls prevent cross currents between an inlet port 7 and an outlet port 8 on the same side of the cell 2.

FIGS. 7 and 8, both show an electrochemical stack 1 comprising a plurality of electrochemical cell 2. The stacks 1 are provided with inlet channels 3 for supplying a fluid and outlet channels 4 for discharging the fluid. The inlet channels 3 and the outlet channels 4 extend over the height of the stacks 1 and are open at one end of the respective stack 1. In FIG. 7, the inlet channel 3 and the outlet channel 4 or open at opposite ends of the stack 1. In FIG. 8, the inlet channel 3 and the outlet channel 4 are open at the same end of the stack 1. A stack 1 according to the present invention can have both designs.

1. A method of operating an electrochemical stack (1), comprising a plurality of electrochemical cells (2), comprising the steps:
supplying the electrochemical cells (2) with a fluid via inlet channels (3) that extend in a stacking direction through the electrochemical stack (1) and are provided on opposite sides (S1, S2) of the electrochemical stack (1); and
discharging the fluid via outlet channels (4) that extend in the stacking direction through the electrochemical stack (1) and are provided opposite the inlet channels (3), such that the fluid flows through each electrochemical cell (2) in two substantially opposite directions (D1, D2).

2. The method according to claim 1,
wherein the fluid flow through the electrochemical cells (2) is guided by guide elements (5) and/or cell partitions (6).

3. The method according to claim 1,
wherein the fluid supplied via a single inlet channel (3) is discharged via two or more outlet channels (4) that are provided opposite the respective inlet channel (3).

4. An electrochemical cell (2) for an electrochemical stack (1) having a plurality of inlet ports (7) provided on opposite sides (S1, S2) of the electrochemical cell (2) and a plurality of outlet ports (8) provided opposite the inlet ports (7), such that either side (S1, S2) of the electrochemical cell (2) is provided with at least one inlet port (7) and at least one outlet port (8).

5. The electrochemical cell (2) according to claim 4,
wherein a number of the outlet ports (8) is at least twice a number of the inlet ports (7).

6. The electrochemical cell (2) according to claim 4,
wherein a flow cross-section of the inlet ports (7) in total is smaller than a flow cross-section of the outlet ports (8) in total.

7. The electrochemical cell (2) according to claim 4,
wherein guide elements (5) and/or cell partitions (6) are provided for separating flow paths with opposite flow directions (D1, D2).

8. An electrochemical stack (1) comprising a plurality of electrochemical cells (2) according to claim 4.

9. The electrochemical stack (1) according to claim 8,
wherein the inlet ports (7) of the electrochemical cells (2) overlap and define inlet channels (3) extending through the electrochemical stack (1) in a stacking direction and the outlet ports (8) of the cells (2) overlap and define outlet channels (4) extending through the electrochemical stack (2) in the stacking direction.

10. The method according to claim 1, wherein the electrochemical stack (1) is an electrolysis stack and wherein the electrochemical cells (2) are electrolysis cells.

11. The electrochemical cell (2) according to claim 4, wherein the electrochemical stack (1) is an electrolysis stack and wherein the electrochemical cell (2) is an electrolysis cell.
